(19) United States
(12) Patent Application Publication
(10) Pub. No.: US 2011/0263212 A1
(43) Pub. Date: Oct. 27, 2011

(54) WIRELESS DEVICE AND CONTROLLING METHOD OF WIRELESS DEVICE

(76) Inventors: Chih-Hao Yeh, Taipei County (TW); Jui-Ming Wei, Taichung City (TW)

(21) Appl. No.: 12/767,795

(22) Filed: Apr. 26, 2010

(51) Int. Cl. H04B 1/38; H04B 17/00

(52) U.S. Cl. 455/73; 455/115.1

(57) ABSTRACT

A wireless device includes at least a transmitter to transmit a transmitting signal; a triggering device arranged to monitor an operating status of the wireless device when the transmitter is transmitting the transmitting signal; and a controller arranged to control the transmitter to adjust a throughput of the transmitting signal when the operating status is determined to satisfy a predetermined criterion.

### BACKGROUND

The present invention relates to a wireless device and a controlling method of the wireless device, and more particularly to a wireless device that adjusts a throughput of a transmitting signal according to an operating status and related controlling method.

A combo IC (Integrated circuit) comprises a multiple of wireless transceivers integrated therein. To reduce the size of the combo IC, the combo IC is always stuffed with the wireless transceivers in a way to sacrifice the heat dissipating capability. As a result, the temperature of the combo IC may be increased to an overheat level when some of the wireless transceivers in the combo IC operated concurrently. For example, if a Bluetooth transmitter and a WLAN (Wireless Local Area Network) transmitter are turned on concurrently for transmitting their signals respectively, the power amplifiers of the Bluetooth transmitter and the WLAN transmitter generates large amount of heat, and in consequence increases the temperature of the combo IC. To avoid the malfunctions of the wireless transceivers, the temperature of the combo IC should be reduced. In addition, when a transmitter and a receiver in the combo IC are turned on concurrently for transmitting a transmitted signal and receiving a received signal respectively, the transmitted signal generated by the transmitter may interfere with the received signal since the transmitter and the receiver are co-located in the combo IC. As a result, the received signal is impacted by the transmitted signal since the power of the transmitted signal always much higher than the received signal.

Accordingly, the combo IC suffers performance degradation resulting from the above-mentioned problems, therefore providing a mechanism to avoid or reduce the impacts on the combo IC by referring to the operating status of the combo IC is a significant concern in this field.

### SUMMARY

An objective of the present invention provides a wireless device and related controlling method for adjusting a throughput of a transmitting signal according to an operating status and related controlling method. The overheat and co-existence problems met by the prior ICs can be improved with the present controlling method.

A controlling method for a wireless device having at least a transmitter is disclosed. The controlling method comprises the steps of: enabling the transmitter to transmit a transmitting signal; monitoring an operating temperature of the wireless device when the transmitter is transmitting the transmitting signal; and when the operating temperature reaches a predetermined temperature threshold, controlling the transmitter to adjust a throughput of the transmitting signal.

A controlling method for a wireless device having at least a transmitter is disclosed. The controlling method comprises the steps of: enabling the transmitter to transmit a transmitting signal; monitoring a supply voltage status of the wireless device when the transmitter is transmitting the transmitting signal; and when the supply voltage status reaches a predetermined supply voltage status threshold, controlling the transmitter to adjust a throughput of the transmitting signal.

A controlling method for a wireless device having at least a transmitter and a receiver is disclosed, where the receiver and the transmitter are co-located in the wireless device. The controlling method comprises the steps of: enabling the receiver to receive a receiving signal; enabling the transmitter to transmit a transmitting signal; monitoring a signal quality of the receiving signal received by the receiver when the transmitter is transmitting the transmitting signal; and when the signal quality reaches a predetermined signal quality threshold, controlling the transmitter to adjust a throughput of the transmitting signal.

A controlling method for a wireless device having at least a transmitter and a receiver is disclosed, where the receiver and the transmitter are co-located in the wireless device. The controlling method comprises the steps of: enabling the receiver to receive a receiving signal; enabling the transmitter to transmit a transmitting signal; monitoring a type of the receiving signal received by the receiver when the transmitter is transmitting the transmitting signal; and when the receiving signal carries real-time information, controlling the transmitter to adjust a throughput of the transmitting signal.

A wireless device is disclosed. The wireless device comprises a transmitter, a triggering device, and a controller. The transmitter is arranged to transmit a transmitting signal. The triggering device is arranged to monitor an operating temperature of the wireless device when the transmitter is transmitting the transmitting signal. The controller is arranged to control the transmitter to adjust a throughput of the transmitting signal when the operating temperature reaches a predetermined temperature threshold.

A wireless device is disclosed. The wireless device comprises a transmitter, a triggering device, and a controller. The transmitter is arranged to transmit a transmitting signal. The triggering device is arranged to monitor a supply voltage status of the wireless device when the transmitter is transmitting the transmitting signal. The controller is arranged to control the transmitter to adjust a throughput of the transmitting signal when the supply voltage status reaches a predetermined supply voltage status threshold.

A wireless device is disclosed. The wireless device comprises a receiver, a transmitter, a triggering device, and a controller. The receiver is arranged to receive a receiving signal. The transmitter is arranged to transmit a transmitting signal, wherein the receiver and the transmitter are co-located in the wireless device. The triggering device is arranged to monitor a signal quality of the receiving signal received by the receiver when the transmitter is transmitting the transmitting signal. The controller is arranged to control the transmitter to adjust a throughput of the transmitting signal when the signal quality reaches a predetermined signal quality threshold.

A wireless device is disclosed. The wireless device comprises a receiver, a transmitter, a triggering device, and a controller. The receiver is arranged to receive a receiving signal. The transmitter is arranged to transmit a transmitting signal, wherein the receiver and the transmitter are co-located in the wireless device. The triggering device is arranged to monitor a type of the receiving signal received by the receiver when the transmitter is transmitting the transmitting signal. The controller is arranged to control the transmitter to adjust a throughput of the transmitting signal when the receiving signal carries real-time information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless device according to an embodiment of the present invention.

FIG. 2 is a flowchart illustrating a controlling method of the wireless device according to a second embodiment of the present invention.

FIG. 3(A) is a timing diagram illustrating a WLAN transmitting signal before and after adjusted by a micro-controller of the wireless device.

FIG. 3(B) is a timing diagram illustrating the WLAN transmitting signal after adjusted by the micro-controller of the wireless device.

FIG. 4 is a flowchart illustrating a controlling method of the wireless device according to a third embodiment of the present invention.

FIG. 5 is a flowchart illustrating a controlling method of the wireless device according to a fourth embodiment of the present invention.

FIG. 6 is a flowchart illustrating a controlling method of the wireless device according to a fifth embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

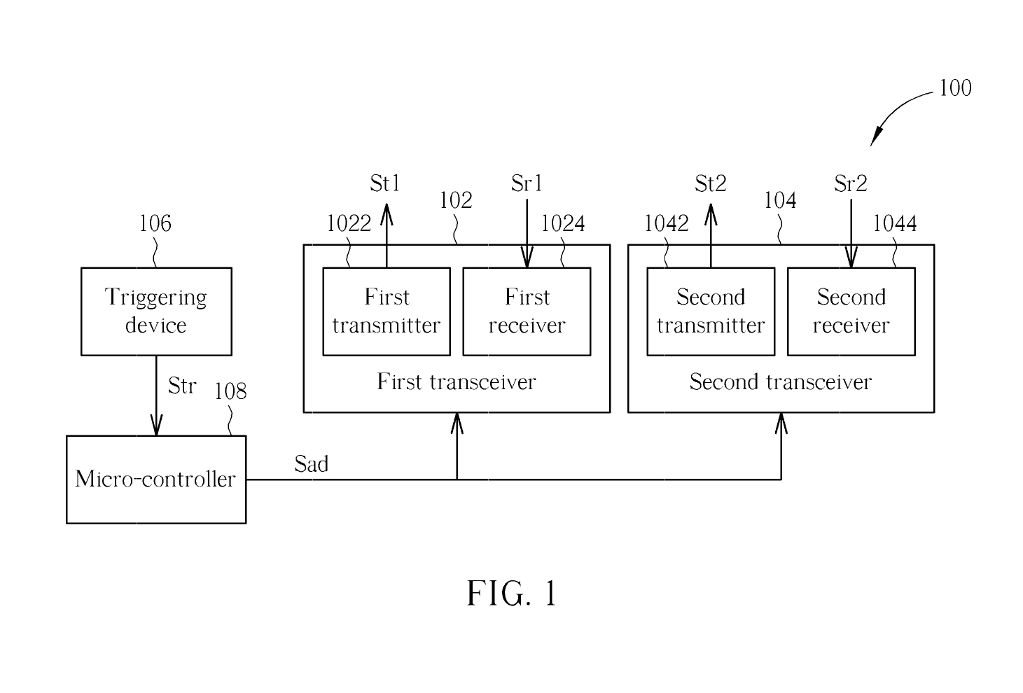

FIG. 1 is a diagram illustrating a wireless device 100 according to an embodiment of the present invention. The wireless device 100 may include a combo chip comprising at least a first transceiver 102 and a second transceiver 104, or include two chips each comprising a transceiver 102/104 and the two transceivers 102 and 104 are placed closely in the wireless device 100. The first transceiver 102 may be a WLAN (Wireless Local Area Network) transceiver and the second transceiver 104 may be a Bluetooth transceiver, and it should be noted that this is not the limitation of the present invention. For brevity, however, the first transceiver 102 is the WLAN transceiver and the second transceiver 104 is the Bluetooth transceiver hereinafter. Furthermore, the first transceiver 102 comprises a first transmitter 1022 and a first receiver 1024, and the second transceiver 104 comprises a second transmitter 1042 and a second receiver 1044, wherein the first transmitter 1022 is arranged to transmit a WLAN transmitting signal St1, the first receiver 1024 is arranged to receive a WLAN receiving signal Sr1, the second transmitter 1042 is arranged to transmit a Bluetooth transmitting signal St2, and the second receiver 1044 is arranged to receive a Bluetooth receiving signal Sr2. However, please be noted that the present invention is not limited to separate transmitter and receiver configuration; the transmitting functionality and the receiving functionality may be accomplished in one module or share between modules. The wireless device 100 further comprises a triggering device 106 and a micro-controller 108. The triggering device 106 is arranged to monitor an operating status of the wireless device 100 when at least one transmitter in the wireless device 100 is transmitting a signal. It should be noted that the triggering device 106 can be embedded into the wireless device 100 or externally coupled with the wireless device 100. The micro-controller 108 is coupled to the triggering device 106 and is arranged to control the transmitter 1022 and/or 1042 under transmitting to adjust a throughput of the signal when the operating status of the wireless device 100 satisfies a predetermined condition. Please note that, according to the embodiment, the micro-controller 108 substantially keeps a transmitting peak power of the transmitter under transmitting intact while the micro-controller 108 adjusts the throughput of the signal. Furthermore, the micro-controller 108 may utilize the media access control (MAC) mechanism existed in the wireless device 100 to adjust the throughput of the transmitting signal. Furthermore, the present invention is not limited to monitoring just one operating status of the wireless device 100 when the wireless device 100 is under operation, the triggering device 106 may monitor a variety of operating status of the wireless device 100 when the wireless device 100 is under operation. For example, the operating status may be the operating temperature of the wireless device 100, the signal quality of the receiving signal Sr1 or Sr2, the type of the receiving signal Sr1 or Sr2, or/and the supply voltage status of the wireless device 100.

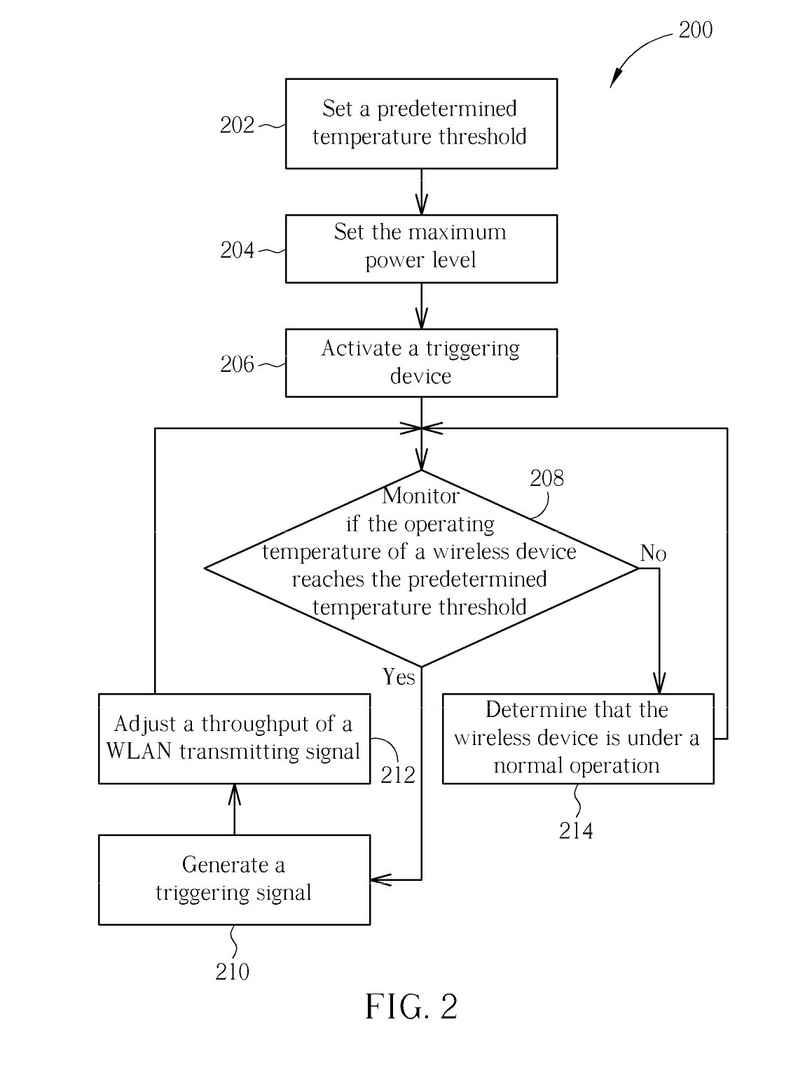

Please refer to FIG. 2. FIG. 2 is a flowchart illustrating a controlling method 200 of the wireless device 100 according to a second embodiment of the present invention. Provided that substantially the same result is achieved, the steps of the flowchart shown in FIG. 2 need not be in the exact order shown and need not be contiguous, that is, other steps can be intermediate. In this embodiment, the controlling method 200 is provided for decreasing the operating temperature (i.e., the operating status is the operating temperature in this embodiment) of the wireless device 100 when the operating temperature reaches a predetermined temperature threshold. Therefore, the controlling method 200 monitors the operating temperature of the wireless device 100 by a thermal sensor or the like (not shown in FIG. 1) when the first transmitter 1022 is transmitting the WLAN transmitting signal St1, however this is not the limitation of the present invention. In another embodiment, the controlling method is provided for monitoring the operating temperature of the wireless device 100 when the second transmitter 1042 is transmitting the Bluetooth transmitting signal St2, or when both the first transmitter 1022 and the second transmitter 1042 are transmitting the WLAN transmitting signal St1 and the Bluetooth transmitting signal St2 respectively at the same time. In addition, the controlling method 200 may be partly or entirely implemented by software or by hardware. The controlling method 200 comprises the following steps:

Step 202: Set the predetermined temperature threshold;

Step 204: Set the maximum power level of the WLAN transmitting signal St1;

Step 206: Activate the triggering device 106 when the first transmitter 1022 is transmitting the WLAN transmitting signal St1 with the maximum power level;

Step 208: Utilize the triggering device 106 to monitor if the operating temperature of the wireless device 100 reaches the predetermined temperature threshold, if yes go to 210, if no go to step 214;

Step 210: Determine that the predetermined condition is satisfied, the triggering device 106 generates a triggering signal Str to the micro-controller 108;

Step 212: Utilize the micro-controller 108 to decrease the throughput of the first transmitter 1022 under transmitting to adjust a throughput of the WLAN transmitting signal St1, go to step 208;

Step 214: Determine that the wireless device 100 is under a normal operation, go to step 208.

It should be noted that, since the first transmitter 1022 and the second transmitter 1042 are co-located in the combo wireless device 100, the power amplifier of the first transmitter 1022 or the second transmitter 1042 may generate large amount of heat when one of (or both) the first transmitter 1022 and the second transmitter 1042 is turned on for transmitting signal with the maximum power level. Furthermore, the definition of co-location may be defined by implementing the first transmitter 1022 and the second transmitter 1042 in a single chip or placing the first transmitter 1022 and the second transmitter 1042 closed to each other. Then, the triggering device 106 is activated to monitor if the operating temperature of the wireless device 100 reaches the predetermined temperature threshold, wherein when the operating temperature is lower than the predetermined temperature threshold, the triggering device 106 determines that the wireless device 100 is under the normal operation, and when the operating temperature is not lower than the predetermined temperature threshold, the triggering device 106 determines that the wireless device 100 is under an overheat operation. When the wireless device 100 is determined to operate under the overheat operation, the triggering device 106 generates the triggering signal Str to trigger the micro-controller 108. Then, the micro-controller 108 controls the first transmitter 1022 to decrease the throughput of the WLAN transmitting signal St1. Then, the operating temperature of the wireless device 100 decreases as the throughput of the WLAN transmitting signal St1 is decreased.

After step 212, the wireless device 100 is controlled to go to the step 208 to perform the similar procedure in order to ensure the wireless device 100 entering the safe mode. In addition, in step 214, even when the wireless device 100 is operated under the normal operation, the triggering device 106 continues to monitor the operating temperature of the wireless device 100 until the first transmitter 1022 finishes the transmission of the WLAN transmitting signal St1. In should be noted that the present invention does not limit the predetermined temperature threshold to be a fixed temperature, the predetermined temperature can also be a temperature range having a upper bound and a lower bound, in which is the status of wireless device 100 is determined as the overheat operation when the operating temperature is higher than the upper bound and is determined as the normal operation when the operating temperature is lower than the low bound. And the threshold and the upper/lower bound may be adjustable to reflect manufacturing variation, component aging, and so on.

Furthermore, the present invention discloses various ways to adjust the throughput of the WLAN transmitting signal St1. Here, the throughput represents packet amount transmitted in a unit time slot. When the triggering device 106 determines that the wireless device 100 is under the overheat operation, the triggering device 106 generates the triggering signal Str to trigger the micro-controller 108 to output an adjusting signal Sad for adjusting an idle time between two packets transmitted via the WLAN transmitting signal St1. According to the specifications of IEEE 802.11, the micro-controller 108 may adjust the IFS (Inter Frame Space) of the WLAN transmitting signal (for example, extend the IFS) to adjust the idle time between two packets in the WLAN transmitting signal St1. More specifically, the micro-controller 108 adjusts the settings of AIFSN and Win Size of the first transmitter 1022 to adjust the idle time between two packets in the WLAN transmitting signal St1.

In another embodiment of the present invention, the micro-controller 108 may adjust the Network Allocation Vector (NAV) of the WLAN transmitting signal to adjust the idle time between two packets in the WLAN transmitting signal St1. In this embodiment, the micro-controller 108 may use the virtual carrier sense to block the transmission of the WLAN transmitting signal St1. In other words, the micro-controller 108 sets the idle time before the WLAN transmitting signal St1 is transmitted by the first transmitter 1022 to adjust the idle time between two packets in the WLAN transmitting signal St1.

In another embodiment of the present invention, the micro-controller 108 may adjust the admission control upon the first transmitter 1022 to adjust the idle time between two packets in the WLAN transmitting signal St1. In this embodiment, the micro-controller 108 reduces the allowed medium time usage per second of the first transmitter 1022 to increase the idle time between two packets in the WLAN transmitting signal St1.

Furthermore, in another embodiment of the present invention, the micro-controller 108 may adjust the delay time between each packet of the WLAN transmitting signal St1 to adjust the idle time between two packets in the WLAN transmitting signal St1. In this embodiment, the micro-controller 108 reduces the number of aggregated MPDU or aPPDUMaxTime of the first transmitter 1022 to increase the idle time between two packets in the WLAN transmitting signal St1.

Except for the above-present embodiments, another embodiment of the present invention is to adjust the length of at least one packet of the WLAN transmitting signal St1 to adjust throughput of the WLAN transmitting signal St1. In this embodiment, the micro-controller 108 may reduce the data bytes, the data rate, or the packet number of aggregation for transmitting the packet of the WLAN transmitting signal St1 to decrease the throughput of the WLAN transmitting signal St1.

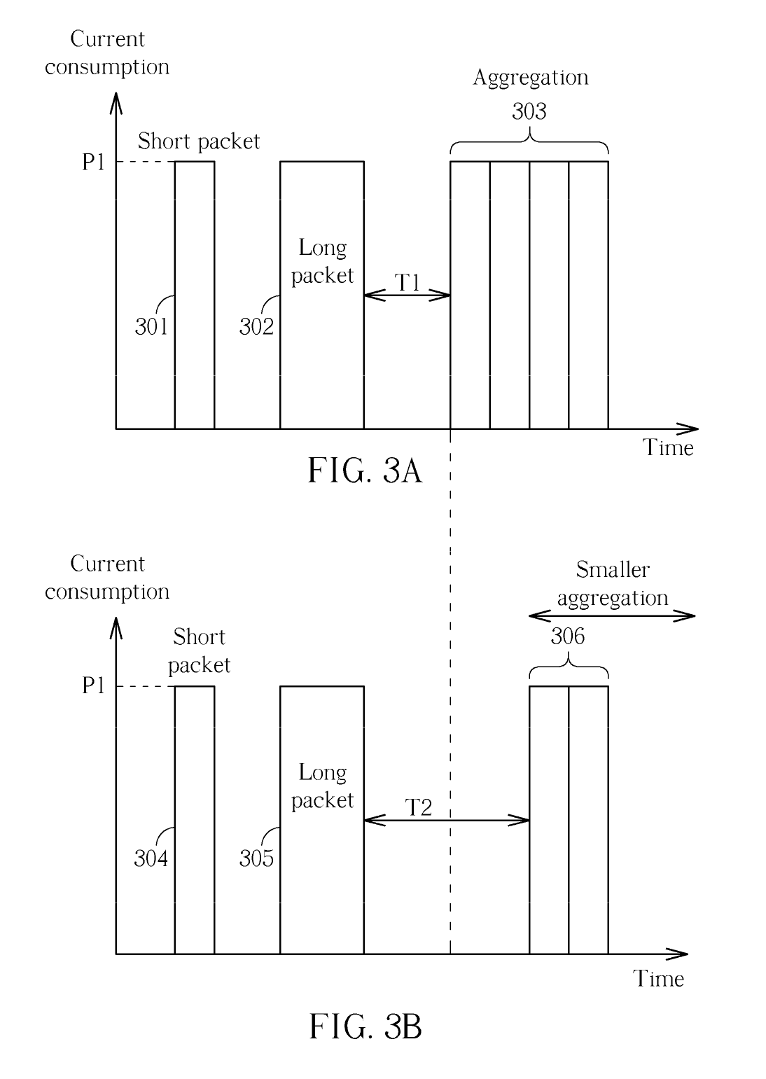

Please refer to FIG. 3. FIG. 3(A) is a timing diagram illustrating the WLAN transmitting signal St1 before adjusted by the micro-controller 108 of the present invention, and FIG. 3(B) is a timing diagram illustrating the WLAN transmitting signal St1 after adjusted by the micro-controller 108 of the present invention. If a short packet (i.e., higher rate) 301, a long packet (i.e., lower rate) 302, and an aggregation 303 are transmitted by the first transmitter 1022 without the adjustment of the micro-controller 108, the inter-frame-space between the long packet 302 and the aggregation 303 is T1, and the number of the aggregation 303 is four (just an example, not the limitation). However, after the adjustment of the micro-controller 108 is done upon the first transmitter 1022, the inter-frame-space between the long packet 305 and the aggregation 306 is adjusted to T2, which is larger than T1, and the number of the aggregation 306 is adjusted to two (just an example, not the limitation), which is a smaller aggregation. Therefore, the throughput of the WLAN transmitting signal St1 is reduced and the average transmitted power (i.e., the current consumption) of the first transmitter 1022 is reduced. It should be noted that, although the average transmitted power of the first transmitter 1022 is reduced, the peak transmitted power (i.e., the peak current consumption P1 in FIG. 3(B) of the power amplifier of the first transmitter 1022) of the first transmitter 1022 substantially equals to the peak transmitted power (i.e., the peak current consumption P1 in FIG. 3(A) of the power amplifier of the first transmitter 1022) without the adjustment of the micro-controller 108. Since the peak transmitted powers of the first transmitter 1022 before and after adjustment are substantially equal, the transmission ranges (the covered area that the first transmitter 1022 provides the WLAN service) of the WLAN transmitting signal St1 before and after adjustment are substantially equal. In other words, the wireless device 100 reduces the average transmitted power of the first transmitter 1022 without scarifying (i.e., shortening) the transmission range of the WLAN transmitting signal St1.

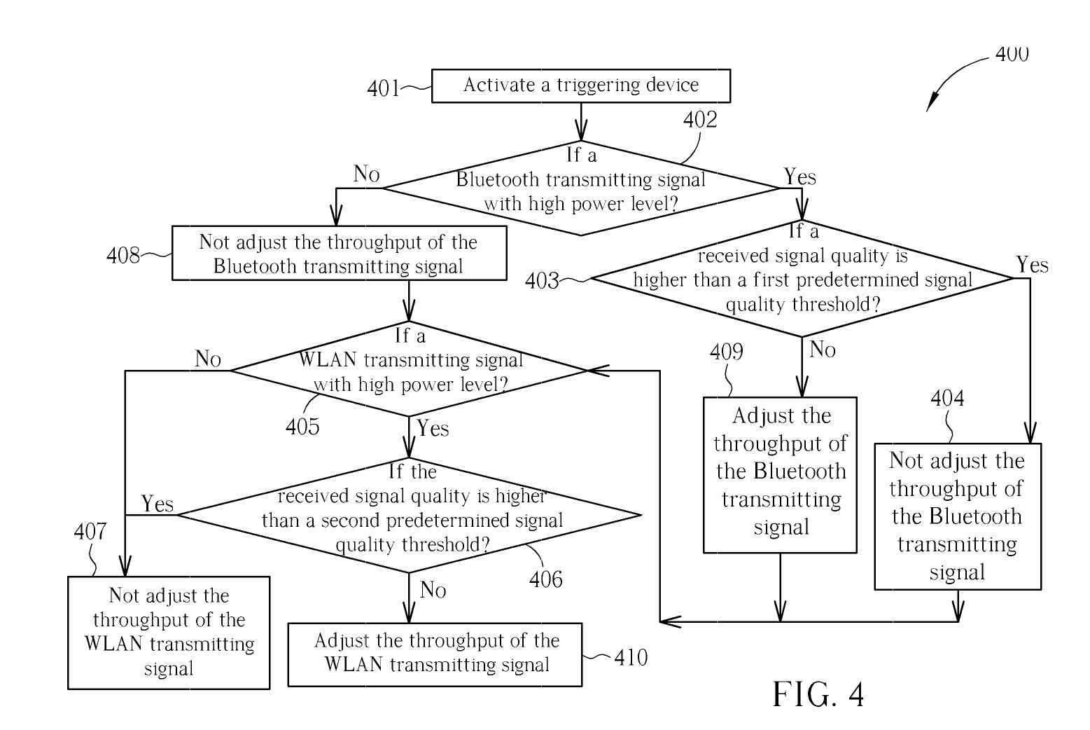

Please refer to FIG. 4. FIG. 4 is a flowchart illustrating a controlling method 400 of the wireless device 100 according to a third embodiment of the present invention. Provided that substantially the same result is achieved, the steps of the flowchart shown in FIG. 4 need not be in the exact order shown and need not be contiguous, that is, other steps can be intermediate. In this embodiment, the controlling method 400 is provided for solving the interference problem between the transmitting signal and the receiving signal of the wireless device 100 when one transmitter is transmitting the transmitting signal and another receiver is receiving the receiving signal at the same time. It should be noted that the interference problem can be serious if the transmitter and the receiver are co-located in the combo wireless device 100. The controlling method 400 comprises the following steps:

Step 401: When one transmitter is transmitting the transmitting signal and another receiver is receiving the receiving signal at the same time, activate the triggering device 106;

Step 402: Utilize the triggering device 106 to detect if the second transmitter 1042 is transmitting the Bluetooth transmitting signal St2 with high power level, if yes go to step 403, if no go to step 408;

Step 403: Utilize the triggering device 106 to detect if the received signal quality of the WLAN receiving signal Sr1 received by the first receiver 1024 is higher than a first predetermined signal quality threshold, if yes go to step 404, if no go to step 409;

Step 404: Do not adjust the throughput of the Bluetooth transmitting signal St2;

Step 405: Utilize the triggering device 106 to detect if the first transmitter 1022 is transmitting the WLAN transmitting signal St1 with high power level, if yes go to step 406, if no go to step 407;

Step 406: Utilize the triggering device 106 to detect if the received signal quality of the Bluetooth receiving signal Sr2 received by the second receiver 1044 is higher than a second predetermined signal quality threshold, if yes go to step 407, if no go to step 410;

Step 407: Do not adjust the throughput of the WLAN transmitting signal St1;

Step 408: Do not adjust the throughput of the Bluetooth transmitting signal St2, go to Step 405;

Step 409: Adjust the throughput of the Bluetooth transmitting signal St2, go to Step 405;

Step 410: Adjust the throughput of the WLAN transmitting signal St1.

It should be noted that the first predetermined signal quality threshold may equal to the second predetermined signal quality threshold in another embodiment of the present invention. When the triggering device 106 detects that the second transmitter 1042 is transmitting the Bluetooth transmitting signal St2 with high power level and the received signal quality (e.g., the received-signal strength indicator (RSSI), the signal-to-noise ratio (SNR), the packet error rate, or the ack loss rate) of the WLAN receiving signal Sr1 received by the first receiver 1024 is not higher than the first predetermined signal quality threshold at the same time, meaning that the WLAN receiving signal Sr1 may be interfered by the Bluetooth transmitting signal St2 or may not be strong enough to against the interfere caused by the Bluetooth transmitting signal St2, then the micro-controller 108 generates the adjusting signal Sad to control the second transmitter 1042 to reduce the throughput of the Bluetooth transmitting signal St2 (step 409). Otherwise, the WLAN receiving signal Sr1 may not be interfered by the Bluetooth transmitting signal St2 or may be strong enough to against the interfere caused by the Bluetooth transmitting signal St2, then the micro-controller 108 does not adjust the throughput of the Bluetooth transmitting signal St2 (step 404).

On the other hand, when the triggering device 106 detects that the first transmitter 1022 is transmitting the WLAN transmitting signal St1 with high power level and the received signal quality of the Bluetooth receiving signal Sr2 received by the second receiver 1044 is not higher than the second predetermined signal quality threshold at the same time, meaning that the Bluetooth receiving signal Sr2 may be interfered by the WALN transmitting signal St1 or may not be strong enough to against the interfere caused by the WALN transmitting signal St1, then the micro-controller 108 generates the adjusting signal Sad to control the first transmitter 1022 to reduce the throughput of the WLAN transmitting signal St1 (step 410). Otherwise, the Bluetooth receiving signal Sr2 may not be interfered by the WLAN transmitting signal St1 or may be strong enough to against the interfere caused by the WALN transmitting signal St1, then the micro-controller 108 does not adjust the throughput of the WLAN transmitting signal St1 (step 407).

In addition, when the triggering device 106 detects that the power of the Bluetooth transmitting signal St2 generated by the second transmitter 1042 is not the high power level (step 402), the micro-controller 108 may not adjust the throughput of the Bluetooth transmitting signal St2 (step 408). Similarly, when the triggering device 106 detects that the power of the WLAN transmitting signal St1 generated by the first transmitter 1022 is not the high power level (step 405), the micro-controller 108 may not adjust the throughput of the WLAN transmitting signal St2 (step 407). It should be noted that the above-mentioned various ways of throughput adjusting method for the transmitting signal, i.e., the WLAN transmitting signal St1 or the Bluetooth transmitting signal St2, are also applicable in this embodiment, thus detailed description is omitted here for brevity.

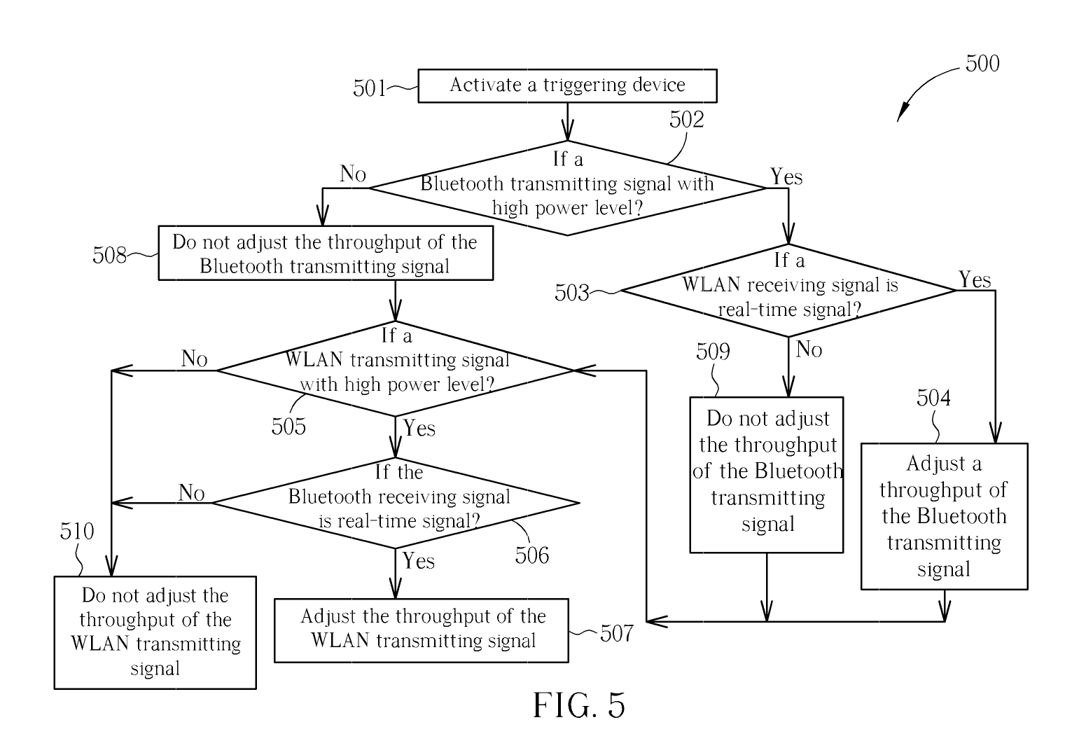

In some cases, the wireless device 100 may utilized for receiving a signal carrying real-time information such as audio packets via one of the receivers, then the real-time signal should not be interfered by other signal generated by the co-located transmitter. For example, when the Bluetooth receiving signal Sr2 received by the second receiver 1044 is the real-time signal, the Bluetooth receiving signal Sr2 should not be interfered by the WLAN transmitting signal St1 transmitted by the first transmitter 1022 at the same time. Therefore, another embodiment is disclosed for reducing the interference upon the real-time receiving signal in the wireless device 100 as shown in FIG. 5. FIG. 5 is a flowchart illustrating a controlling method 500 of the wireless device 100 according to a fourth embodiment of the present invention. Provided that substantially the same result is achieved, the steps of the flowchart shown in FIG. 5 need not be in the exact order shown and need not be contiguous, that is, other steps can be intermediate. In this embodiment, the controlling method 500 is provided for solving the interference problem between the transmitting signal and the receiving signal of the wireless device 100 when one transmitter is transmitting the transmitting signal and another receiver is receiving the real-time receiving signal at the same time. It should be noted that the interference problem can be serious if the transmitter and the receiver are co-located in the combo wireless device 100. The controlling method 500 comprises the following steps:

Step 501: When one transmitter is transmitting the transmitting signal and another receiver is receiving the receiving signal at the same time, activate the triggering device 106;

Step 502: Utilize the triggering device 106 to detect if the second transmitter 1042 is transmitting the Bluetooth transmitting signal St2 with high power level, if yes go to step 503, if no go to step 508;

Step 503: Utilize the triggering device 106 to detect if the WLAN receiving signal Sr1 received by the first receiver 1024 is the real-time signal, if yes go to step 504, if no go to step 509;

Step 504: Adjust the throughput of the Bluetooth transmitting signal St2;

Step 505: Utilize the triggering device 106 to detect if the first transmitter 1022 is transmitting the WLAN transmitting signal St1 with high power level, if yes go to step 506, if no go to step 510;

Step 506: Utilize the triggering device 106 to detect if the Bluetooth receiving signal Sr2 received by the second receiver 1044 is the real-time signal, if yes go to step 507, if no go to step 510;

Step 507: Adjust the throughput of the WLAN transmitting signal St1;

Step 508: Do not adjust the throughput of the Bluetooth transmitting signal St2, go to Step 505;

Step 509: Do not adjust the throughput of the Bluetooth transmitting signal St2, go to Step 505;

Step 510: Do not adjust the throughput of the WLAN transmitting signal St1.

When the triggering device 106 detects that the second transmitter 1042 is transmitting the Bluetooth transmitting signal St2 with high power level and the WLAN receiving signal Sr1 received by the first receiver 1024 is the real-time signal at the same time, meaning that the WLAN receiving signal Sr1 should not be interfered by the Bluetooth transmitting signal St2, then the micro-controller 108 generates the adjusting signal Sad to control the second transmitter 1042 to reduce the throughput of the Bluetooth transmitting signal St2 (step 504). Otherwise, the WLAN receiving signal Sr1 is not the real-time signal, then the micro-controller 108 may not adjust the throughput of the Bluetooth transmitting signal St2 (step 509).

On the other hand, when the triggering device 106 detects that the first transmitter 1022 is transmitting the WLAN transmitting signal St1 with high power level and the Bluetooth receiving signal Sr2 received by the second receiver 1044 is the real-time signal at the same time, meaning that the Bluetooth receiving signal Sr2 should not be interfered by the WALN transmitting signal St1, then the micro-controller 108 generates the adjusting signal Sad to control the first transmitter 1022 to reduce the throughput of the WLAN transmitting signal St1 (step 507). Otherwise, the Bluetooth receiving signal Sr2 is not the real-time signal, then the micro-controller 108 may not adjust the throughput of the WLAN transmitting signal St1 (step 510).

In addition, when the triggering device 106 detects that the power of the Bluetooth transmitting signal St2 generated by the second transmitter 1042 is not the high power level (step 502), the micro-controller 108 may not adjust the throughput of the Bluetooth transmitting signal St2 (step 508). Similarly, when the triggering device 106 detects that the power of the WLAN transmitting signal St1 generated by the first transmitter 1022 is not the high power level (step 505), the micro-controller 108 may not adjust the throughput of the WLAN transmitting signal St2 (step 510). Similarly, the above-mentioned various ways of throughput adjusting method for the transmitting signal, i.e., the WLAN transmitting signal St1 or the Bluetooth transmitting signal St2, are also applicable in this embodiment, thus detailed description is omitted here for brevity.

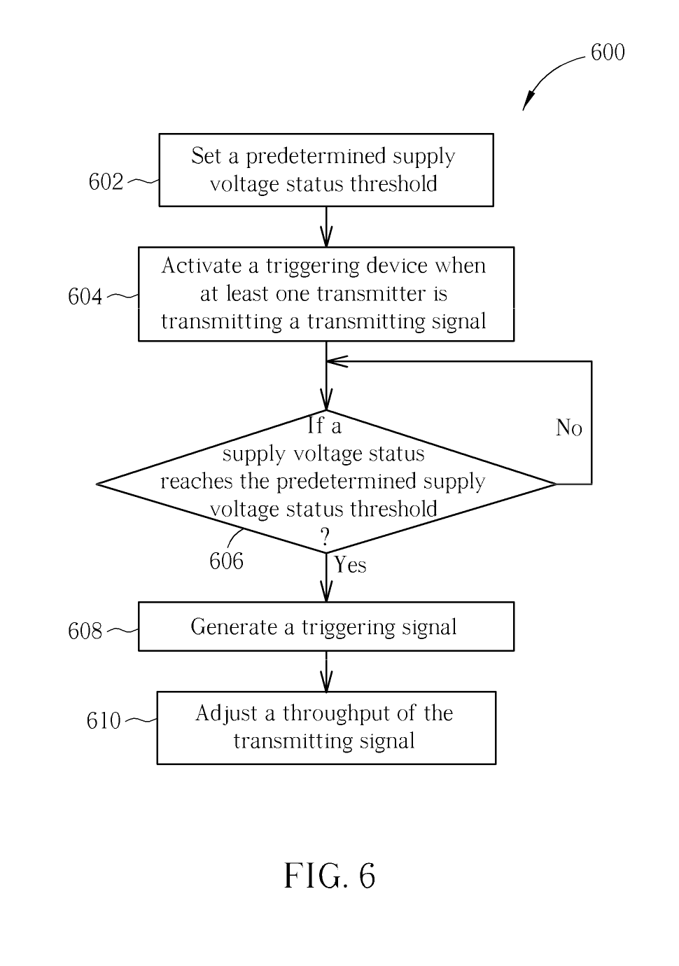

Since the power amplifier of a transmitter in the wireless device 100 may consume the maximum power in the wireless device 100, another embodiment is disclosed for reducing the throughput of the transmitting signal of the wireless device 100 when the supply voltage status of the wireless device 100 reaches a predetermined supply voltage status threshold as shown in FIG. 6. FIG. 6 is a flowchart illustrating a controlling method 600 of the wireless device 100 according to a fifth embodiment of the present invention. Provided that substantially the same result is achieved, the steps of the flowchart shown in FIG. 6 need not be in the exact order shown and need not be contiguous, that is, other steps can be intermediate. In this embodiment, the controlling method 600 is provided for extending the using time of the wireless device 100 when the supply voltage status reaches the predetermined supply voltage threshold (for example, the “battery low” situation occurs) and at least one transmitter is transmitting the transmitting signal at the same time. The controlling method 600 comprises the following steps:

Step 602: Set the predetermined supply voltage status threshold;

Step 604: Activate the triggering device 106 when at least one transmitter in the wireless device 100 is transmitting the transmitting signal;

Step 606: Utilize the triggering device 106 to monitor if the supply voltage status reaches the predetermined supply voltage status threshold, if yes go to 608, if no go to step 606;

Step 608: Determine that the predetermined condition is satisfied, the triggering device 106 generates a triggering signal Str to the micro-controller 108;

Step 610: Utilize the micro-controller 108 to decrease the throughput of the transmitter under transmitting to adjust the throughput of the transmitting signal.

When the triggering device 106 determines that the supply voltage status reaches the predetermined supply voltage status threshold, meaning the battery supplying to the wireless device 100 is under the low battery status, therefore the average power consumption of the transmitter under transmitting should be reduced to extend the using time of the battery. Then, the micro-controller 108 generates the adjusting signal Sad to the transmitter to decrease the throughput of the transmitting signal (step 610). It should be noted that the above-mentioned various ways of throughput adjusting method for the transmitting signal, i.e., the WLAN transmitting signal St1 or the Bluetooth transmitting signal St2, are also applicable in this embodiment, the detailed description is omitted here for brevity.

Briefly, the present controlling method(s) reuses the media access control (MAC) mechanism existed in the wireless device 100 to adjust the throughput of the transmitting signal while the transmitting peak power of the transmitting signal can be maintained according to a variety of operating status of the wireless device 100, such as the operating temperature of the wireless device 100, the signal quality of the receiving signal, the type of the receiving signal, or/and the supply voltage status of the wireless device 100. Moreover, the five embodiments mentioned above can be selectively combined to provide composite triggering conditions. For example, the triggering device 106 may monitor both signal quality indicator and the operating temperature, and dynamically determine whether to control the micro-controller 108 to adjust the throughput of the wireless device 100. Since a person with ordinary skill in the art should appreciate the operations under the composite triggering conditions after reading above disclosure, detailed description is omitted for brevity.

Those skilled in the art will readily observe that numerous modifications and alterations of the device and method may be made while retaining the teachings of the invention.

What is claimed is:

1. A controlling method for a wireless device having at least a transmitter, comprising:
enabling the transmitter to transmit a transmitting signal;
monitoring an operating temperature or a supply voltage status of the wireless device when the transmitter is transmitting the transmitting signal; and
when the operating temperature or the supply voltage status reaches a predetermined threshold, controlling the transmitter to adjust a throughput of the transmitting signal.

2. The controlling method of claim 1, wherein the step of controlling the transmitter to adjust the throughput of the transmitting signal comprises:
substantially keeping a transmitting peak power of the transmitter intact while adjusting the throughput of the transmitting signal.

3. The controlling method of claim 1, wherein the step of controlling the transmitter to adjust the throughput of the transmitting signal comprises:
adjusting an idle time between two packets transmitted via the transmitting signal.

4. The controlling method of claim 3, wherein the step of adjusting the idle time between two packets transmitted via the transmitting signal comprises:
adjusting an IFS (Inter Frame Space) of the transmitting signal.

5. The controlling method of claim 3, wherein the step of adjusting the idle time between two packets transmitted via the transmitting signal comprises:
adjusting a Network Allocation Vector (NAV) of the transmitter.

6. The controlling method of claim 3, wherein the step of adjusting the idle time between two packets transmitted via the transmitting signal comprises:
adjusting an allowed medium time usage per second of the transmitter.

7. The controlling method of claim 3, wherein the step of adjusting the idle time between two packets transmitted via the transmitting signal comprises:
adjusting a delay time between each packet of the transmitting signal.

8. The controlling method of claim 1, wherein the step of controlling the transmitter to adjust the throughput of the transmitting signal comprises:
adjusting a length of at least one packet of the transmitting signal.

9. The controlling method of claim 8, wherein the step of adjusting the length of one packet of the transmitting signal comprises:
adjusting data bytes, a data rate, or a packet number of aggregation for transmitting the at least one packet of the transmitting signal.

10. A controlling method for a wireless device having at least a transmitter and a receiver, where the receiver and the transmitter are co-located in the wireless device, the controlling method comprising:
enabling the receiver to receive a receiving signal;
enabling the transmitter to transmit a transmitting signal;
monitoring a signal quality or a type of the receiving signal received by the receiver when the transmitter is transmitting the transmitting signal; and
when the signal quality reaches a predetermined signal quality threshold or when the receiving signal carries real-time information, controlling the transmitter to adjust a throughput of the transmitting signal.

11. A wireless device, comprising:
a transmitter, arranged to transmit a transmitting signal;
a triggering device, arranged to monitor an operating temperature or a supply voltage status of the wireless device when the transmitter is transmitting the transmitting signal; and
a controller, arranged to control the transmitter to adjust a throughput of the transmitting signal when the operating temperature or the supply voltage status reaches a predetermined threshold.

12. The wireless device of claim 11, wherein the controller substantially keeps a transmitting peak power of the transmitter intact while the controller adjusts the throughput of the transmitting signal.

13. The wireless device of claim 11, wherein the controller adjusts an idle time between two packets transmitted via the transmitting signal to adjust the throughput of the transmitting signal.

14. The wireless device of claim 11, wherein the controller adjusts a length of at least one packet of the transmitting signal to adjust a throughput of the transmitting signal.

15. A wireless device, comprising:
a receiver, arranged to receive a receiving signal;
a transmitter, arranged to transmit a transmitting signal, wherein the receiver and the transmitter are co-located in the wireless device;
a triggering device, arranged to monitor a signal quality or a type of the receiving signal received by the receiver when the transmitter is transmitting the transmitting signal; and
a controller, arranged to control the transmitter to adjust a throughput of the transmitting signal when the signal quality reaches a predetermined signal quality threshold or when the receiving signal carries real-time information.
